(19) United States
(12) Patent Application Publication
(10) Pub. No.: US 2007/0059539 A1
(43) Pub. Date: Mar. 15, 2007

(54) USE OF EPOXY-FUNCTIONAL SILANES AS ADHESION ADDITIVES FOR CATIONICALLY RADIATION CURING SILICONE RELEASE COATINGS

(75) Inventors: Hardi Doehler, Duesseldorf (DE); Michael Ferenz, Essen (DE); Sascha Herrwerth, Essen (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/530,562

(22) Filed: Sep. 11, 2006

(30) Foreign Application Priority Data
Sep. 14, 2005 (DE) 10 2005 043 742.7

(51) Int. Cl. B32B 9/04

(52) U.S. Cl. 428/447

(57) ABSTRACT

The invention provides a method of improving the adhesion of radiation-cured adhesive silicone release coatings on films or polymer-coated paper through use of adhesion additives, which method comprises using, as adhesion additives, epoxy-functional silanes of the general formula (III)

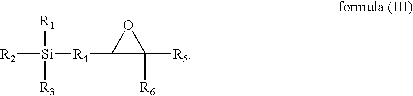

This application claims benefit under 35 U.S.C. 119(a) of German patent application DE 10 2005 043 742.7, filed on 14 Sep. 2005.

Any foregoing applications, including German patent application DE 10 2005 043 742.7, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The present invention relates to the use of epoxy-functional silanes as adhesion additives for cationically radiation-curing silicone release coatings on films or polymer-coated paper.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Adhesive coating compositions are used to a wide extent to coat materials, especially sheet materials, in order to reduce the adhesion tendency of adhering products for these surfaces.

Adhesive coating compositions are used, for example, to coat papers or films which are intended to serve as backings for self-adhesive labels.

The labels, provided with a pressure-sensitive adhesive, do still adhere to the coated surface to a sufficient extent to allow the backing films carrying the adhesive labels to be handled.

The adhesion of the adhesive labels to the backing films must be sufficiently high that during machine application of labels to containers, for example, the labels do not separate prematurely as the backing films with their labels run via deflection rollers.

However, the labels must be able to be removed from the coated backing film without any substantial impairment to their bond strength for subsequent use.

For this purpose the curing and adhesion of the silicone release layer must be particularly good, since otherwise silicone components may transfer to the surface of the adhesive and reduce the bond strength.

Further possible uses for adhesive coating compositions are packaging papers, which are used in particular for packaging sticky goods.

Adhesive papers or films of this kind are used, for example, to pack foodstuffs or to pack industrial products, such as bitumen, for example.

A further application of adhesive coating compositions is in the production of self-stick closures, such as for disposable diapers, for example.

If the adhesiveness is too high, i.e., if the release force is too low, the diaper does not stay reliably closed.

If the adhesiveness is too low and thus the release force too high, the closure can no longer be opened without destructive tearing of the diaper.

In all cases the stability of the adhesiveness over long periods is important for the function of adhesive coatings. There must be no notable increase or reduction in the release force.

Since the 1980s, two radiation-curing adhesive coating compositions have been known in the market.

One system cures by a free-radical mechanism following exposure to UV radiation or electron beams. Systems of this kind are described in, for example, U.S. Pat. Nos. 4,201,808; 4,568,566; 4,678,846; 5,494,979; 5,510,190; 5,804,301; and 5,977,282 and are available commercially under the names Tego RC 902, Tego RC 711 or Tego RC 715, for example.

The other system cures by a cationic mechanism. These systems are composed of organopolysiloxanes which contain reactive groups and cure under UV radiation. These reactive groups may be epoxy groups, vinyl ether groups, alkenyloxy groups such as vinyloxy groups or propenyloxy groups. Substances of this kind are described in, for example, U.S. Pat. Nos. 5,057,549; 5,231,157; 4,421,904; 4,547,431; 4,952,657; 5,217,805; 5,279,860; 5,340,898; 5,360,833; 5,650,453; 5,866,261; and 5,973,020. The polymerizable groups in systems of this kind are typically epoxy groups. Products of this kind are available commercially under the names GE UV 9300, GE UV 9400, Tego RC 1411, Tego 1402 or Tego RC 1400, for example.

Cationic photopolymerization is a quick, efficient, and environmentally benign way of curing cationically polymerizable monomers.

Particularly efficient photoinitiators are diaryliodonium (I) and triarylsulfonium (II) salts. 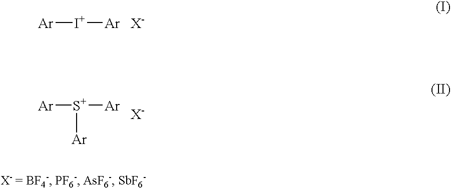
in which Ar radicals are identical or different aromatic radicals which if desired may contain heteroatoms and/or further substituent radicals.

Diaryliodonium salts (I) in particular are known from the patent literature (GB 1 516 352 (U.S. Pat. No. 4,058,400), U.S. Pat. No. 4,279,717, EP 0 334 056 (U.S. Pat. No. 4,882,201), U.S. Pat. No. 5,468,890) and are used as photoinitiators for polymerizing cationically polymerizable substances. If desired, it is possible in addition to use cocatalysts in order to achieve more rapid curing.

The epoxy-functionalized siloxanes have very good release coating properties, and the cured coatings exhibit effective adhesion on substrates such as paper. On plastic films or polymer-coated paper (polyethylene, polypropylene, polystyrene, and polyesters), in contrast, their adhesion is inadequate.

EP-1 116 761 (U.S. Pat. No. 6,312,818) describes various adhesion additives. Compounds described as being particularly suitable are bis(trialkoxysilylalkyl)fumarates, bis(trialkoxysilylalkyl)maleates, bis(trialkoxysilylalkyl)succinates, and bis(trialkoxysilylalkyl)phthalates.

EP 1 116 761 further describe that the two epoxy-functional silanes 3-glycidyloxypropyltrimethoxysilane and 2-(3,4-epoxycyclohexyl)ethyltrimethoxysilane are unsuitable as adhesion additives for cationically radiation-curing silicone release coatings on film or polymer-coated paper because improved adhesion is not achieved.

The object on which the present invention is based, therefore, is to provide further, commercially available adhesion additives for cationically radiation-curing silicone release coatings on film or polymer-coated paper that allow a significant improvement in the adhesion to critical substrates (polyethylene, polypropylene, polystyrene, and polyesters) and do not lead to poor aging properties.

Accordingly, it is an object of the invention to not encompass within the invention any previously known product, process of making the product or method of using the product such that applicant(s) reserve the right and hereby disclose a disclaimer of any previously known product, process of making the product or method of using the product.

The invention accordingly provides a method of improving the adhesion of radiation-cured adhesive silicone release coatings on films or polymer-coated paper through use of adhesion additives, which method comprises using, as adhesion additives, at least one epoxy-functional silane of the general formula (III) 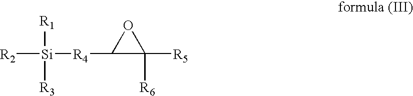
in which
R₁, R₂, and R₃ radicals are identical or different alkyl, alkoxy, aryl, or aryloxy radicals having 1 to 20 carbon atoms, or alkenyl radicals having 2 to 20 carbon atoms, at least one radical being an alkoxy or aryloxy group,
R₄ radicals are alkenyl radicals having 2 to 20 carbon atoms, and optionally comprise ether, ester, urethane or amide groups,
R₅ radicals are H or alkyl groups having 1 to 20 carbon atoms, and
R₆ radicals are H, alkyl groups having 1 to 20 carbon atoms or alkylene groups having 2 to 5 carbon atoms which with R₄ form a cyclic ring.

Another embodiment of the invention is use of at least one epoxy-functional silane of the general formula (III) in which
R₁, R₂, and R₃ radicals are identical or different alkyl, alkoxy, aryl, or aryloxy radicals having 1 to 4 carbon atoms, or alkenyl radicals having 2 to 4 carbon atoms, at least one radical being an alkoxy or aryloxy group,
R₄ radicals are alkenyl radicals having 2 to 4 carbon atoms, and optionally comprise ether, ester, urethane or amide groups,
R₅ radicals are H or alkyl groups having 1 to 4 carbon atoms, and
R₆ radicals are H, alkyl groups having 1 to 4 carbon atoms.

Yet another embodiment of the invention is use of at least one epoxy-functional silane of the general formula (III) in which
R₁, R₂, and R₃ radicals are identical or different and are methoxy or ethoxy,
R₄ radicals are alkenyl radicals having 2 carbon atoms, and optionally comprise ether, ester, urethane or amide groups,
R₅ radicals are H or methyl, and
R₆ radicals are H or methyl.

Surprisingly, it has been found that, in contrast to the disadvantages from the invention of EP-1 116 761, it is possible through the use of epoxy-functional silanes to achieve a marked improvement in the adhesion of cationically curing silicone release coatings to films or polymer-coated paper.

Particularly positive effects on the adhesion of the cationically curing silicone release coatings are found for silicone release coatings which comprise at least one component which in addition to the epoxy groups also carries, partially, hydroxyl groups.

The invention accordingly further provides a method of improving the adhesion of radiation-cured adhesive silicone release coatings to films or polymer-coated paper through use of adhesion additives, which method comprises the cationically radiation-curing silicone release coatings comprising at least one component of the general formula (IV) 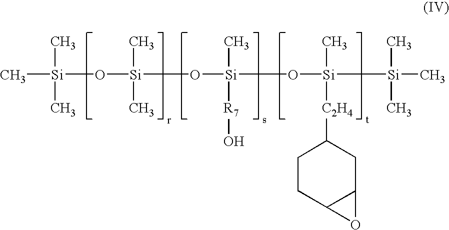
in which
R₇ radicals are alkenyl groups having 2 to 20 carbon atoms, and optionally comprise ether, ester, urethane or amide groups, or
   are polyether radicals of the general formula (V)
   —(CH₂)ₙ—[CH₂—CH(R₈)—O]ₘ—H (V)
R₈ radicals are identical or different radicals from the following group:
   alkyl radicals having 1-20 carbon atoms, H, or aryl radicals having 6-20 carbon atoms,
   n is 3-10,
   m is 1-100,
   r is 0 to 1000,
   s is 0.1 to 100, and
   t is 1 to 100.

In another embodiment of the invention, is use of the polyether radicals of the general formula (IV) in which:
R₇ radicals are alkenyl groups having 2 to 4 carbon atoms, and optionally comprise ether, ester, urethane or amide groups; or
R₈ radicals are identical or different radicals from the following group:
   alkyl radicals having 1-4 carbon atoms, H, or aryl radicals having 6-10 carbon atoms,
   n is 3-10,
   m is 1-100,
   r is 2 to 200,
   s is 0.1 to 10, and
   t is 2 to 40.

In yet another embodiment of the invention, is use of the polyether radicals of the general formula (IV) in which:
R₇ radicals are alkenyl groups having 2 carbon atoms, and optionally comprise ether, ester, urethane or amide groups; or
R₈ radicals are identical or different radicals from the following group:
   methyl, H, or aryl radicals having 6 carbon atoms,
   n is 3-10,
   m is 1-100,
   r is 2 to 200,
   s is 0.1 to 10, and
   t is 2 to 40.

Compounds of this kind are available commercially under the name Tego RC 1402, for example.

A further possibility when using epoxy-functional silanes of the general formula (III) as adhesion additives is to add adjuvants, such as fillers, cocatalysts or pigments, for example, to the cationically radiation-curing epoxy-functionalized siloxanes. Selection of appropriate adhesion additives are well known to those of ordinary skill in the art, see e.g. Chemistry and Technology of Silicones, Noll, W., Verlag Chemie GmbH (1968); Coatings Technology Handbook (2^{nd} Ed.), Tractor and Salas (eds.), Marcel Dekker (2000); Handbook of Adhesives Technology (2^{nd} Ed.), Pizzi et al., Marcel Dekker (2003); Pressure-Sensitive Adhesive and Applications (2^{nd} Ed.), Benedek, Istvan, Marcel Dekker (2004); Adhesion and Adhesives Technology, Pocius, A. V., Carl Hanser Verlag (2002).

The epoxy-functional silanes of the general formula (III) are employed in a concentration of 0.1 to 10 percent by weight, based on the total composition (epoxy-functional siloxane, photoinitiator, and, if desired, filler). In another embodiment of the invention, the epoxy-functional silanes of the general formula (III) have a concentration of 0.5 to 5 percent by weight, based on the total composition.

In one embodiment of the invention, the adhesive silicone release coatings when applied to a substrate (e.g. films or polymer-coated paper), provide a release force of about 50 to 60 cN/inch and passes the rub-off test within 5 minutes at room temperature upon completion of curing of the silicone release coating.

In another embodiment of the invention, the adhesive silicone release coatings when applied to a substrate, provide a release force of about 53 to 58 cN/inch and passes the rub-off test within 1 minute at room temperature upon completion of curing of the silicone release coating.

For the purposes of this application, the adhesion additive is not the same as the silicone component of the silicone release coatings of the invention.

The invention is further described by the following non-limiting examples which further illustrate the invention, and are not intended, nor should they be interpreted to, limit the scope of the invention.

### EXAMPLES

The following compounds were employed as adhesion additives—
Comparative 1: bis(trialkoxysilylalkyl)fumarates
Additive 1: 3-glycidyloxypropyltrimethoxysilane
Additive 2: 2-(3,4-epoxycyclohexyl)ethyltrimethoxy silane

at 0%, 2%, and 5% by weight in different cationically curing silicone formulations. The silicone formulations contained a diaryliodonium salt (TEGO RC 1465 from Goldschmidt) and also commercially available organo-polysiloxanes which were equipped with epoxy groups capable of cationic polymerization. According to ¹H NMR analysis, the product GE UV 9300 contains epoxy groups but no hydroxyl groups. In the commercially available product TEGO RC 1402 there are hydroxyl groups detectable as well as epoxy groups. Both products, after curing, give a very adhesive silicone coat with comparable release properties. The tested mixtures of these components are summarized in table 1.

TABLE 1

| No. | Silicone | Photoinitiator | Adhesion additive |
|---|---|---|---|
| 1 | GE UV 9300, | TEGO RC 1465, | none |
| | 98% | 2% | |
| 2 | GE UV 9300, | TEGO RC 1465, | Comparative 1, |
| | 96% | 2% | 2% |
| 3 | GE UV 9300, | TEGO RC 1465 | Comparative 1, |
| | 93% | 2% | 5% |
| 4 | TEGO RC 1402, | TEGO RC 1465, | none |
| | 98% | 2% | |
| 5 | TEGO RC 1402, | TEGO RC 1465, | Comparative 1, |
| | 96% | 2% | 2% |
| 6 | TEGO RC 1402, | TEGO RC 1465, | Comparative 1, |
| | 93% | 2% | 5% |
| 7 | GE UV 9300, | TEGO RC 1465, | Additive 1, |
| | 96% | 2% | 2% |
| 8 | GE UV 9300, | TEGO RC 1465, | Additive 1, |
| | 93% | 2% | 5% |
| 9 | TEGO RC 1402, | TEGO RC 1465, | Additive 1, |
| | 96% | 2% | 2% |
| 10 | TEGO RC 1402, | TEGO RC 1465, | Additive 1, |
| | 93% | 2% | 5% |
| 11 | GE UV 9300, | TEGO RC 1465, | Additive 2, |
| | 96% | 2% | 2% |
| 12 | GE UV 9300, | TEGO RC 1465, | Additive 2, |
| | 93% | 2% | 5% |
| 13 | TEGO RC 1402, | TEGO RC 1465 | Additive 2, |
| | 96% | 2% | 2% |
| 14 | TEGO RC 1402, | TEGO RC 1465, | Additive 2 |
| | 93% | 2% | 5% |

Mixtures 1 to 14 were then applied using a five-roll applicator on a pilot line to a polyester film from Mitsubishi, type RC 36. The coat weight was 1.0 g/m². The coating was subsequently cured using a microwave-excited UV lamp (Fusion, 120 W/cm) at a rate of 20 m/min.
(A) The release force of the release coatings was determined in accordance with FINAT test method No. 10. This was done using the commercial adhesive tape (25 mm wide) TESA® 7476 from Beiersdorf. To measure the adhesiveness, these adhesive tapes were rolled onto the release coating and subsequently stored at 40° C. under a weight of 70 g/cm². After 24 h the force is measured that is required to remove the respective adhesive tape from the substrate with a peel angle of 180° at a speed of 30 cm/min. This force is termed the release force.
(B) The determination of the adhesion of the silicone to the substrate was determined by means of a simple, subjective test which is common in the industry. In this test, referred to as the rub-off test, the silicone coating is rubbed reproducibly with the index finger. The test here was carried out by 10-fold circular motion in a radius of approximately 2 cm, with moderate pressure. The test was carried out directly after curing and also after 24 hours of storage at room temperature. The test is passed if no silicone components can be rubbed from the substrate.

The results are summarized in table 2.

TABLE 2

| | | | Release | | |
|---|---|---|---|---|---|
| | | | force | Rub-off | |
| | | | TESA | passed | Rub-off |
| | | Adhesion | 7476 in | imme- | passed |
| No. | Silicone | additive | cN/inch | diately | 24 h |
| 1 | GE UV 9300, | none | 55 | no | no |
| | 98% | | | | |
| 2 | GE UV 9300, | Comparative 1, | 58 | yes | yes |
| | 96% | 2% | | | |
| 3 | GE UV 9300, | Comparative 1, | 59 | yes | yes |
| | 93% | 5% | | | |
| 4 | TEGO RC 1402, | none | 52 | no | no |
| | 98% | | | | |
| 5 | TEGO RC 1402, | Comparative 1, | 55 | yes | yes |
| | 96% | 2% | | | |
| 6 | TEGO RC 1402, | Comparative 1, | 56 | yes | yes |
| | 93% | 5% | | | |
| 7 | GE UV 9300, | Additive 1, | 56 | no | yes |
| | 96% | 2% | | | |
| 8 | GE UV 9300, | Additive 1, | 58 | no | yes |
| | 93% | 5% | | | |
| 9 | TEGO RC 1402, | Additive 1, | 53 | yes | yes |
| | 96% | 2% | | | |
| 10 | TEGO RC 1402, | Additive 1, | 58 | yes | yes |
| | 93% | 5% | | | |
| 11 | GE UV 9300, | Additive 2, | 55 | no | no |
| | 96% | 2% | | | |
| 12 | GE UV 9300, | Additive 2, | 59 | no | yes |
| | 93% | 5% | | | |
| 13 | TEGO RC 1402, | Additive 2, | 55 | yes | yes |
| | 96% | 2% | | | |
| 14 | TEGO RC 1402, | Additive 2, | 58 | yes | yes |
| | 93% | 5% | | | |

Release forces of around 50-60 cN/inch in tandem with good adhesion point to a good-quality release coating. Low release forces and poor adhesion point to poor curing of the silicones. This is not the case for any of the experiments. Release forces in line with expectation, but poor adhesion, in contrast, point to a problem of anchorage of the silicone mixture to the substrate.

From examples 1 and 4 it is evident that neither GE UV 9300 nor TEGO RC 1402 achieve sufficient adhesion to Mitsubishi PET RN 36 under the prevailing coating and curing conditions. Examples 2 and 3 and also 5 and 6 show that good adhesion is achieved by adding the comparative additive.

Examples 7 and 8 and also 11 and 12 show for additives 1 and 2 that good adhesion in GE UV 930, which contains exclusively epoxy groups, is possible but only after storage time. Examples 9 and 10 and also 13 and 14 show that, in contrast, in TEGO RC 1465, which contains hydroxyl groups as well as epoxy groups, good adhesion is made possible immediately after coating.

Hence it is demonstrated that additives 1 and 2 of the invention consistently permit effective adhesion in cationically curing silicones, particularly when they contain hydroxyl groups as well as epoxy groups.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method of improving the adhesion of radiation-cured adhesive silicone release coatings on films or polymer-coated paper, which method comprises adding as adhesion additives, at least one epoxy-functional silane of the general formula (III) 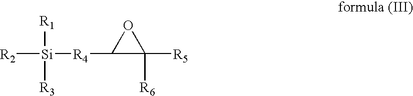
in which
R₁, R₂, and R₃ radicals are identical or different alkyl, alkoxy, aryl, or aryloxy radicals having 1 to 20 carbon atoms, or alkenyl radicals having 2 to 20 carbon atoms, at least one radical being an alkoxy or aryloxy group,
R₄ radicals are alkenyl radicals having 2 to 20 carbon atoms, and optionally comprise ether, ester, urethane or amide groups,
R₅ radicals are H or alkyl groups having 1 to 20 carbon atoms, and
R₆ radicals are H, alkyl groups having 1 to 20 carbon atoms or alkylene groups having 2 to 5 carbon atoms which with R₄ form a cyclic ring.

2. The method of claim 1, wherein:
R₁, R₂, and R₃ radicals are identical or different alkyl, alkoxy, aryl, or aryloxy radicals having 1 to 4 carbon atoms, or alkenyl radicals having 2 to 4 carbon atoms, at least one radical being an alkoxy or aryloxy group,
R₄ radicals are alkenyl radicals having 2 to 4 carbon atoms, and optionally comprise ether, ester, urethane or amide groups,
R₅ radicals are H or alkyl groups having 1 to 4 carbon atoms, and
R₆ radicals are H, alkyl groups having 1 to 4 carbon atoms.

3. The method of claim 2, wherein:
R₁, R₂, and R₃ radicals are identical or different and are methoxy or ethoxy,
R₄ radicals are alkenyl radicals having 2 carbon atoms, and optionally comprise ether, ester, urethane or amide groups,
R₅ radicals are H or methyl, and
R₆ radicals are H or methyl.

4. The method as claimed in claim 1, wherein at least one adhesion additive compound is selected from the group consisting of 3-glycidyloxypropyltrimethoxysilane, 3-glycidyloxypropyltriethoxysilane, 2-(3,4-epoxycyclohexyl)ethyltrimethoxysilane, and 2-(3,4-epoxycyclohexyl)ethyltriethoxysilane.

5. The method as claimed in claim 4, wherein the adhesion additive of the general formula (III) is present in a concentration of 0.1 to 10 percent by weight, based on the total composition.

6. The method as claimed in claim 1, wherein the radiation-cured silicone release coatings comprise at least one component of the general formula (IV) 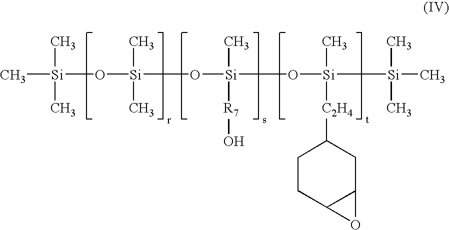
in which
R₇ radicals are alkenyl groups having 2 to 20 carbon atoms, and optionally comprise ether, ester, urethane or amide groups, or
are polyether radicals of the general formula (V)
—(CH₂)ₙ—[CH₂—CH(R₈) —O]ₘ—H (V)
R₈ radicals are identical or different radicals from the following group:
alkyl radicals having 1-20 carbon atoms, H, or aryl radicals having 6-20 carbon atoms,
n is 3-10,
m is 1-100,
r is 0 to 1000,
s is 0.1 to 100, and
t is 1 to 100.

7. The method of claim 6, wherein:
R₇ radicals are alkenyl groups having 2 to 4 carbon atoms, and optionally comprise ether, ester, urethane or amide groups;
or
R₈ radicals are identical or different radicals from the following group:
alkyl radicals having 1-4 carbon atoms, H, or aryl radicals having 6-10 carbon atoms,
n is 3-10,
m is 1-100,
r is 2 to 200,
s is 0.1 to 10, and
t is 2 to 40.

8. The method of claim 7, wherein:
R₇ radicals are alkenyl groups having 2 carbon atoms, and optionally comprise ether, ester, urethane or amide groups.

9. The method of claim 7, wherein:
R₈ radicals are identical or different radicals from the following group:
methyl, H, or aryl radicals having 6 carbon atoms.

10. The method as claimed in claim 4, wherein the cationically radiation-curing silicone release coatings comprise at least one component of the general formula (IV) 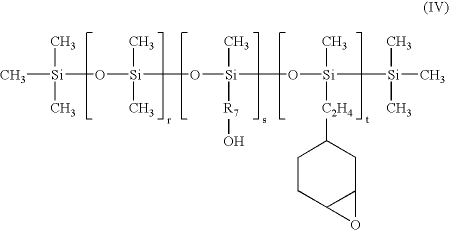
in which
R₇ radicals are alkenyl groups having 2 to 20 carbon atoms, and optionally comprise ether, ester, urethane or amide groups, or
are polyether radicals of the general formula (V)
—(CH₂)ₙ—[CH₂—CH(R₈)—O]ₘ—H (V)
R₈ radicals are identical or different radicals from the following group:
alkyl radicals having 1-20 carbon atoms, H, or aryl radicals having 6-20 carbon atoms,
n is 3-10,
m is 1-100,
r is 0 to 1000,
s is 0.1 to 100, and
t is 1 to 100.

11. The method of claim 10, wherein:
R₇ radicals are alkenyl groups having 2 carbon atoms, and optionally comprise ether, ester, urethane or amide groups,
n is 3-10,
m is 1-100,
r is 2 to 200,
s is 0.1 to 10, and
t is 2 to 40.

12. The method of claim 10, wherein:
R₈ radicals are identical or different radicals from the following group:
methyl, H, or aryl radicals having 6 carbon atoms,
n is 3-10,
m is 1-100,
r is 2 to 200,
s is 0.1 to 10, and
t is 2 to 40.

13. A radiation-cured adhesive silicone release coating for a substrate, which comprises:
(i) at least one silicone component of the general formula (IV) 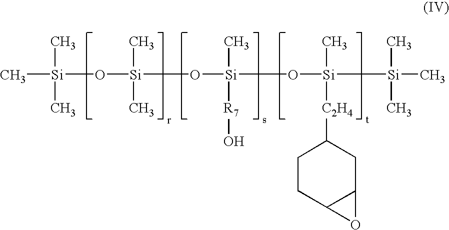
in which
R₇ radicals are alkenyl groups having 2 to 20 carbon atoms, and optionally comprise ether, ester, urethane or amide groups, or
are polyether radicals of the general formula (V)
—(CH₂)ₙ—[CH₂—CH(R₈)—O]ₘ—H (V)
R₈ radicals are identical or different radicals from the following group:
alkyl radicals having 1-20 carbon atoms, H, or aryl radicals having 6-20 carbon atoms,
n is 3-10,
m is 1-100,
r is 0 to 1000,
s is 0.1 to 100, and
t is 1 to 100; and
(ii) an adhesion additive which comprises at least one epoxy-functional silane of the general formula (III) 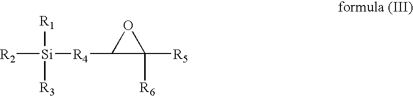
in which
R₁, R₂, and R₃ radicals are identical or different alkyl, alkoxy, aryl, or aryloxy radicals having 1 to 20 carbon atoms, or alkenyl radicals having 2 to 20 carbon atoms, at least one radical being an alkoxy or aryloxy group,
R₄ radicals are alkenyl radicals having 2 to 20 carbon atoms, and optionally comprise ether, ester, urethane or amide groups,
R₅ radicals are H or alkyl groups having 1 to 20 carbon atoms, and
R₆ radicals are H, alkyl groups having 1 to 20 carbon atoms or alkylene groups having 2 to 5 carbon atoms which with R₄ form a cyclic ring,
wherein:
the adhesive silicone release coatings when applied to a substrate, provide a release force of about 50 to 60 cN/inch and passes the rub-off test within 5 minutes at room temperature upon completion of curing of the silicone release coating.

14. The radiation-cured adhesive silicone release coating of claim 13, wherein:
the at least one silicone component of the general formula (IV) of (i) has
R₇ radicals are alkenyl groups having 2 carbon atoms, and optionally comprise ether, ester, urethane or amide groups,
n is 3-10,
m is 1-100,
r is 2 to 200,
s is 0.1 to 10, and
t is 2 to 40; and
the at least one adhesion additive compound is selected from the group consisting of 3-glycidyloxypropyltrimethoxysilane, 3-glycidyloxypropyltriethoxysilane, 2-(3,4-epoxycyclohexyl)ethyltrimethoxysilane, and 2-(3,4-epoxycyclohexyl)ethyltriethoxysilane.

15. The radiation-cured adhesive silicone release coating of claim 13, wherein:
the at least one silicone component of the general formula (V) of (i) has
R₈ radicals are identical or different radicals from the following group:
methyl, H, or aryl radicals having 6 carbon atoms,
n is 3-10,
m is 1-100,
r is 2 to 200,
s is 0.1 to 10, and
t is 2 to 40; and
the at least one adhesion additive compound is selected from the group consisting of 3-glycidyloxypropyltrimethoxysilane, 3-glycidyloxypropyltriethoxysilane, 2-(3,4-epoxycyclohexyl)ethyltrimethoxysilane, and 2-(3,4-epoxycyclohexyl)ethyltriethoxysilane.

16. The radiation-cured adhesive silicone release coating of claim 14, wherein:
the adhesive silicone release coatings when applied to a substrate, provide a release force of about 53 to 58 cN/inch and passes the rub-off test within 1 minute at room temperature upon completion of curing of the silicone release coating.

17. The radiation-cured adhesive silicone release coating of claim 15, wherein:
the adhesive silicone release coatings when applied to a substrate, provide a release force of about 53 to 58 cN/inch and passes the rub-off test within 1 minute at room temperature upon completion of curing of the silicone release coating.

18. The radiation-cured adhesive silicone release
coating of claim 13, wherein the substrate is a film or polymer-coated paper.

19. The radiation-cured adhesive silicone release coating of claim 16, wherein the substrate is a film or polymer-coated paper.

20. The radiation-cured adhesive silicone release coating of claim 17, wherein the substrate is a film or polymer-coated paper.
